(19) United States
(12) Patent Application Publication
(10) Pub. No.: US 2007/0097989 A1
(43) Pub. Date: May 3, 2007

(54) Communication control method

(75) Inventor: Shuichi Sato, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/589,051

(22) Filed: Oct. 30, 2006

(30) Foreign Application Priority Data
Oct. 31, 2005 (JP) P2005-316378

(51) Int. Cl. H04L 12/56

(52) U.S. Cl. 370/395.52

(57) ABSTRACT

According to one embodiment, a communication control method of a communication system which connects an IP network to plural networks including IP communication devices through routers provided for respective networks, which communicates between the IP communication devices of the different networks through the IP network with IP-packetized data, and which includes a first and a second relay servers which relay the IP packet and a control signal to which a global IP address is assigned, the method includes: determining whether peer-to-peer communication between the IP communication devices can be conducted by using a test packet through the first and second relay servers and the router; conducting peer-to-peer communication of the IP data between the IP communication devices determined that the peer-to-peer communication can be conducted; and relaying by the first relay server or second relay server between the IP communication devices determined that the peer-to-peer communication cannot be conducted.

### CROSS-REFERENCE TO RELATED APPLICATIONS

This application is based upon and claims the benefit of priority from Japanese Patent Application No. 2005-316378, filed on Oct. 31, 2005, the entire contents of which are incorporated herein by reference.

### BACKGROUND

1. Field

One embodiment of the invention relates to a communication control method in a communication system for conducting information communication through an IP (Internet Protocol) network and including a router having a conversion function of a private address and a global address.

2. Description of the Related Art

In recent years, a system in which IP-packetized data such as voice, video, a modem, a fax, etc. is transmitted through an IP network has been widely constructed. In the IP network, a router is a key device. The router transfers an IP packet based on a destination address and a source address.

This kind of communication system can be constructed by plural networks through the routers. In such a system, terminals between different networks may be unable to conduct peer-to-peer communication depending on a function of the router. That is, there is a router has a conversion function of a private address and a global address. This kind of router is called a NAT (Network Address Translator) router and is often provided for effective utilization of an IP address. Because of this conversion function, a discrepancy between a source address and a destination address occurs inside the network, and the communication may be restricted from a security aspect.

In order to prepare for such circumstances, it is contemplated to provide a relay server of an IP packet and deliver the IP packet between terminals through this relay server. However, in this technique, a load on the relay server is increased together with an increase in traffic between the terminals, so that it may be difficult to cope with demand for sudden traffic in recent years.

In Japanese Patent Application Publication (Kokai) No. 2005-57388, an IP communication method is disclosed. In this method, an address response server is provided. A packet with IP description of a terminal is sent to the address response server. An address conversion server notifies a response source terminal of a port and a source IP address of the packet received and thereby an address converted by a NAT router can be obtained. Accordingly, direct communication between the terminals can be conducted by obtaining the address converted by the NAT router, but it is necessary to newly provide the address response server in the system.

In Japanese Patent Application Publication (Kokai) No. 2005-57388, an address solution method is disclosed. In the method, outgoing and incoming from another network to a terminal is performed without having a global IP address. In the case of establishing a signal path for call control in the range on a private network, a thread for controlling both the terminals by an address resolution server having a global address is created. An inquiry is made from a VoIP (Voice over IP) server for managing identification information sent from the terminal. A call control signal and a voice signal are relayed between threads for processing the range between terminals for making a call. However, it is necessary to establish signal paths between the address resolution server and all the terminals previously and also peer-to-peer communication between the terminals cannot be conducted.

As described above, when a NAT router is provide in a communication system through an IP network, the NAT router may restrict communication between terminals on different networks. In order to prepare for such circumstances, provision of a relay server is carried out, but a load on the relay server is increased together with an increase in traffic.

### BRIEF DESCRIPTION OF THE SEVERAL VIES OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a communication system according to an embodiment of the invention;

FIG. 2 is an exemplary diagram showing a function of a router;

FIG. 3 is an exemplary sequence diagram showing communication enabling determination processing according to the embodiment;

FIG. 4 is an exemplary sequence diagram showing a processing procedure of the case where a router does not pass a packet from another terminal according to the embodiment;

FIG. 5 is an exemplary sequence diagram showing a communication procedure between terminals of the case of a communication enabling OK according to the embodiment;

FIG. 6 is an exemplary sequence diagram showing a communication procedure between terminals of the case of a communication enabling NG according to the embodiment;

FIG. 7 is an exemplary diagram showing one example of a management table of communication enabling or disabling according to the embodiment;

FIG. 8 is an exemplary diagram showing one example of a management table used by the relay server to relay the signal between IP communication devices according to the embodiment;

FIG. 9 is an exemplary flowchart showing a processing procedure of a packet relay in the relay server according to the embodiment;

FIG. 10 is an exemplary flowchart showing a processing procedure of the case of determining whether the relay server relays the signal between IP communication devices based on a kind of the communication according to the embodiment; and

FIG. 11 is an exemplary flowchart showing a processing procedure of the relay server to change an IP address and a port number of a relay destination terminal in case that an IP communication device has not made a connection enabling request according to the embodiment.

### DETAILED DESCRIPTION

Various embodiments according to the invention will be described hereinafter with reference to the accompanying drawings.

In general, according to one embodiment of the invention, there is provided a communication control method of a communication system which connects an IP network to plural networks including IP communication devices through routers provided for respective networks, which communicates between the IP communication devices of the different networks through the IP network with IP-packetized data, and which includes a first relay server and a second relay server which relay the IP packet and a control signal to which a global IP address is assigned, the method comprising: determining whether peer-to-peer communication between the IP communication devices can be conducted by using a test packet through the first and second relay servers and the router; conducting peer-to-peer communication of the IP data between the IP communication devices determined that the peer-to-peer communication can be conducted; and relaying by the first relay server or second relay server between the IP communication devices determined that the peer-to-peer communication cannot be conducted.

As described above, according to one embodiment of the invention, it is determined whether or not peer-to-peer communication between terminals on different networks can be conducted even in any function of a router present in a communication path between IP communication devices. Then, when communication between other networks can be conducted, peer-to-peer communication between terminals is conducted. As a result of this, communication environment through a relay server is implemented only when necessary rather than depending on the relay server blindly, so that a load on the relay server can be reduced.

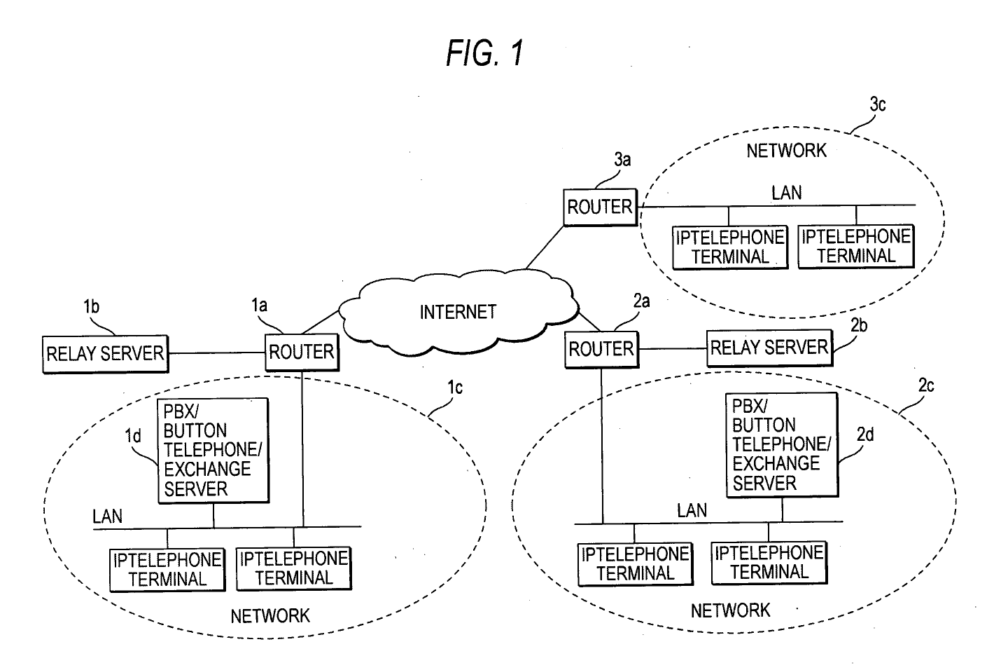

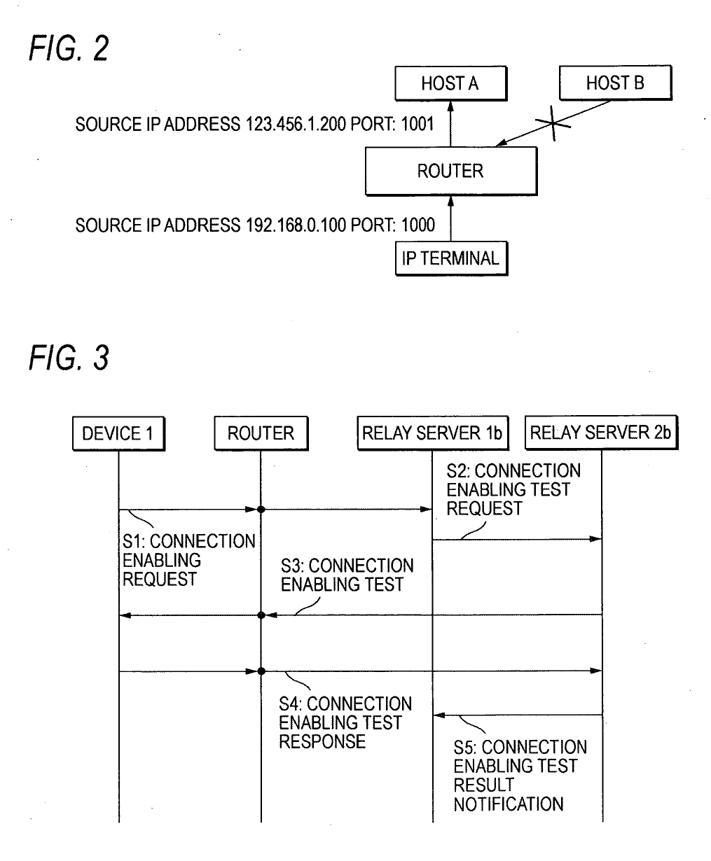

FIG. 1 is an exemplary block diagram showing a communication system according to an embodiment of the invention. In FIG. 1, mutually different networks 1c, 2c, 3c are connected to the Internet through routers 1a, 2a, 3a, respectively. The network 1c includes plural IP telephone terminals disposed on a LAN (Local Area Network) and a PBX(Private Branch eXchanger)/button telephone/exchange server 1d for offering exchange service in an IP to these terminals. The network 2c similarly includes plural IP telephone terminals disposed on a LAN and a PBX/button telephone/exchange server 2d. The network 3c includes only plural IP telephone terminals, but these IP telephone terminals conduct voice communication using the PBX/button telephone/exchange server 1d on the network 1c or the PBX/button telephone/exchange server 2d on the network 2c. The system of FIG. 1 thus takes the form in which plural networks are connected to the IP network through the routers. The system includes relay servers 1b, 2b connected to the networks 1c, 2c, 3c and Internet through the routers 1a, 2a. The relay servers 1b, 2b relay the IP packetized data and a control signal to which a global IP address is assigned. In the system, the IP communication devices are communicated through different communication channels for the control signal and the IP-packetized data. In such a configuration, it may become impossible to conduct communication between terminals of different networks depending on functions of, for example, the routers 1a, 2a. This situation will be described using FIG. 2.

FIG. 2 is an exemplary diagram showing a function of a router. In the case of a communication system includes plural networks as shown in FIG. 2, when the router has a NAT function in the case of communicating from an IP terminal to a host A, a source IP address of the IP terminal may be converted at the router and the converted IP address may be sent to the Internet. For example, it is assumed that the source IP address: 192.168.0.100 and Port No.: 1000 of the IP terminal is converted into IP address: 123.456.1.200 and Port No.: 1001. Then, a router may have a function to restrict access from a device other than the host A (a host B etc.) to the IP address 123.456.1.200 and Port No.: 1001. In this case, there are cases where IP data of voice, video, a fax, a modem, etc. cannot be communicated between the IP terminal of the inside of the network 1c and the IP terminal of the inside of the network 2c in a peer-to-peer manner.

FIG. 3 is an exemplary sequence diagram showing communication enabling determination processing according to the embodiment. The IP communication device 1, such as the PBX/button telephone/exchange server 1d or the IP terminal (e.g., the IP telephone terminal) on the network 1c activates communication enabling determination processing in order to determine whether or not peer-to-peer communication with a terminal on another networkcanbe conducted after a power source is turned on or an error of communication with a relay server occurs.

The IP communication device 1 sends a connection enabling request by a UDP (User Datagram Protocol) packet to a relay server (for example, a relay server 1b) registered previously. This connection enabling request is received by the relay server 1b with the address converted by the router 1a (S1). An IP address of the IP communication device 1 is described in this connection enabling request.

The relay server 1b receives the connection enabling request, and then describes a source IP address and a port number of the UDP packet described in a header thereof in a connection enabling test request for testing enabling or disabling of connection. The relay server 1b sends the connection enabling test request to a relay server 2b having a global IP address (S2). The relay server 2b receives the connection enabling test request, and then sends the UDP packet toward the IP address and the port number described in the connection enabling test request (S3).

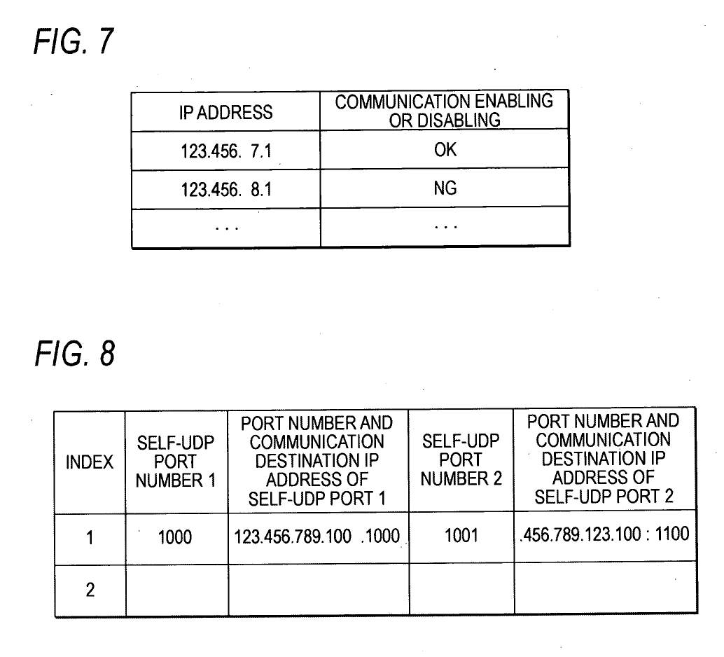

When the router 1a passes an IP packet from a device other than the relay server 1b to which the IP communication device 1 sends the UDP packet, a connection enabling test packet sent from the relay server 2b reaches the IP communication device 1. Hence, the IP communication device 1 receives the connection enabling test packet from the relay server 2b, and then sends a connection enabling test response indicating a result OK to the relay server 2b. The relay server 2b receives this connection enabling test response, and then describes an IP address with a communication enabling OK in a management table as shown in FIG. 7 (S4).

The relay server 1b receives notification of the connection enabling test response from the relay server 2b, and then describes the IP address and the communication enabling OK in the management table of FIG. 7 (S5). In addition, from the second time or later, at a point in time of receiving a connection enabling request from the IP communication device, the management table of FIG. 7 is retrieved and when a request from the same IP address has already been processed, the processing of S2 or later is not performed.

Also, in the relay server 1b, when an IP address of a UDP header of a connection enabling request sent from the IP communication device matches with an IP address described in a connection enabling request sent from the IP communication device, address conversion is not made by a NAT router, so that the procedure of S2 or later is not performed.

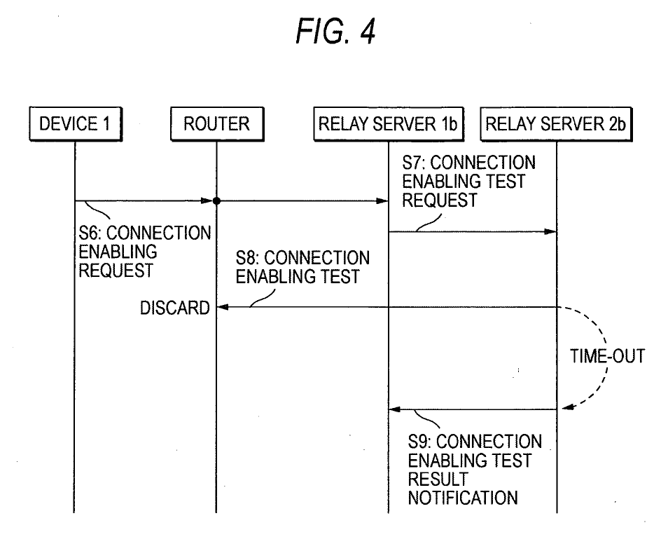

FIG. 4 is an exemplary sequence diagram showing a processing procedure of the case where a router does not pass a packet from another terminal according to the embodiment. In FIG. 4, processing to S6 and S7 is similar to S1 and S2. When a relay server 2b sends a connection enabling test packet to an IP terminal device 1 (S8), a timer is set. The relay server 2b detects that the connection enabling test packet is discarded in a router 1a by time-out of the timer. Then, the relay server 2b describes an IP address and a communication enabling NG in the management table of FIG. 7 and sends connection test result notification to a relay server 1b (S9). The relay server 1b receives the connection test result notification, and then describes the IP address and the communication enabling NG in the management table of FIG. 7.

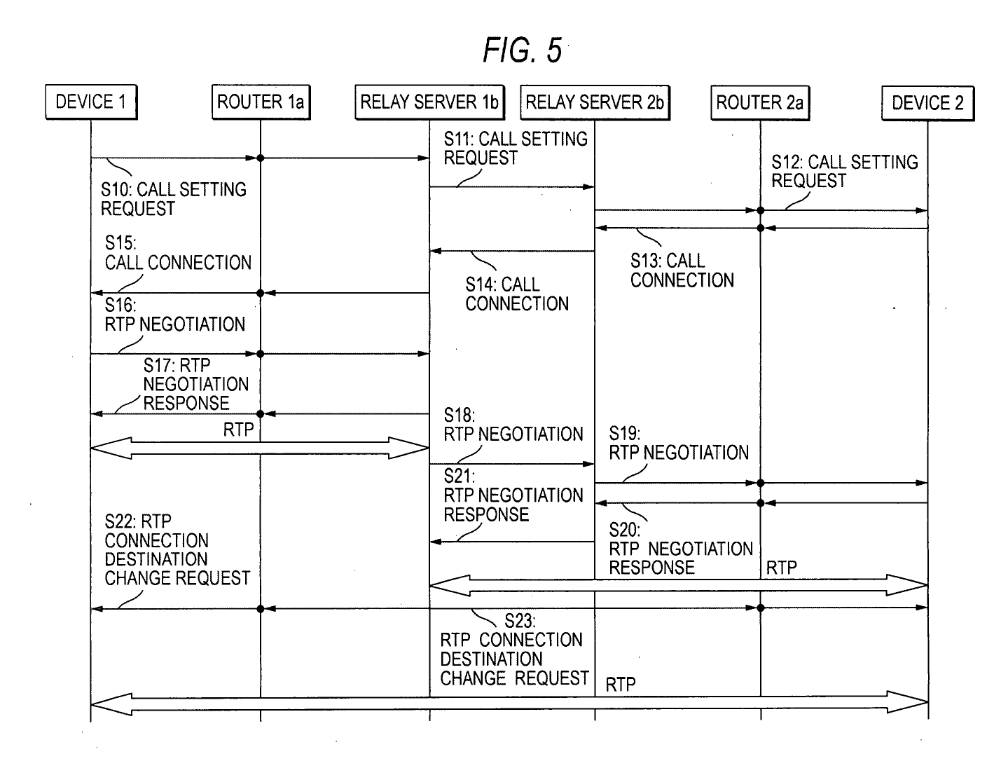

FIG. 5 is an exemplary sequence diagram showing a communication procedure between terminals of the case of a communication enabling OK according to the embodiment. Signals from S10 to S15 are a procedure to make a peer-to-peer call between terminals, and the procedure can also be performed by a standard procedure such as Megaco, H.323 or SIP (Session Initiation Protocol).

In FIG. 5, a call setting request which is an outgoing request from an IP communication device 1 is relayed by a router 1a, a relay server 1b, a relay server 2b and a router 2a, and is received by an IP communication device 2 (opposite destination terminal) (S10 to S12). When the IP communication device 2 answers, call connection notification is relayed by the router 2a, the relay server 2b, the relay server 1b and the router 1a, and is received by the IP communication device 1 (S13 to S15). After receiving this, the IP communication device 1 sends an RTP negotiation request to the relay server 1b of negotiation of an RTP (Real-time Transport Protocol) (S16).

When the router 1a permits communication from another network, the relay server 1b sends an RTP negotiation response to the IP communication device 1 in order to obtain an RTP port number converted by the router 1a, and RTP connection between the relay server 1b and the IP communication device 1 is made (S17). The relay server 1b, in which the RTP is established to the IP communication device 1, sends an RTP negotiation request to the relay server 2b in order to establish an RTP between this relay server 1b and the IP communication device 2 (S18).

The relay server 2b relays the RTP negotiation request sent from the relay server 1b to the IP communication device 2 (S19). The IP communication device 2 receives this RTP negotiation request, and sends an RTP negotiation response to the relay server 1b (S20, S21). Then, an RTP is established between the relay server 1b and the IP communication device 2. The relay server 1b in which an RTP is established to the IP communication device 1 and the IP communication device 2 obtains an IP address and a port number converted by the router 1a from a source IP address and a port number in UDP header information of the RTP sent from the IP communication device 1. Also, the relay server 1b obtains an IP address and a port number converted by the router 2a from a source IP address and a port number in UDP header information of an RTP sent from the IP communication device 2.

The relay server 1b describes the IP address and the port number converted by the router 2a in an RTP connection destination change request and sends the IP address and the port number to the IP communication device 1 (S22). Also, the relay server 1b describes the IP address and the port number converted by the router 1a in an RTP connection destination change request and sends the IP address and the port number to the IP communication device 2 (S23). The IP communication device 1 receives the RTP connection destination change request sent from the relay server 1b, and sends an RTP to the IP address and the port number (described in the RTP connection destination change request) of the IP communication device 2 converted by the router 2a. Also, the IP communication device 2 receives the RTP connection destination change request sent from the relay server 1b, and sends an RTP to the IP address and the port number (described in the RTP connection destination change request) of the IP communication device 1 converted by the router 1a. Thus, IP data of voice/video, a fax, a modem, etc. is delivered between the IP communication device 1 and the IP communication device 2 in a peer-to-peer manner. In addition, in the procedure described above, a standard procedure such as SDP (Session Description Protocol) can also be used as the RTP negotiation request.

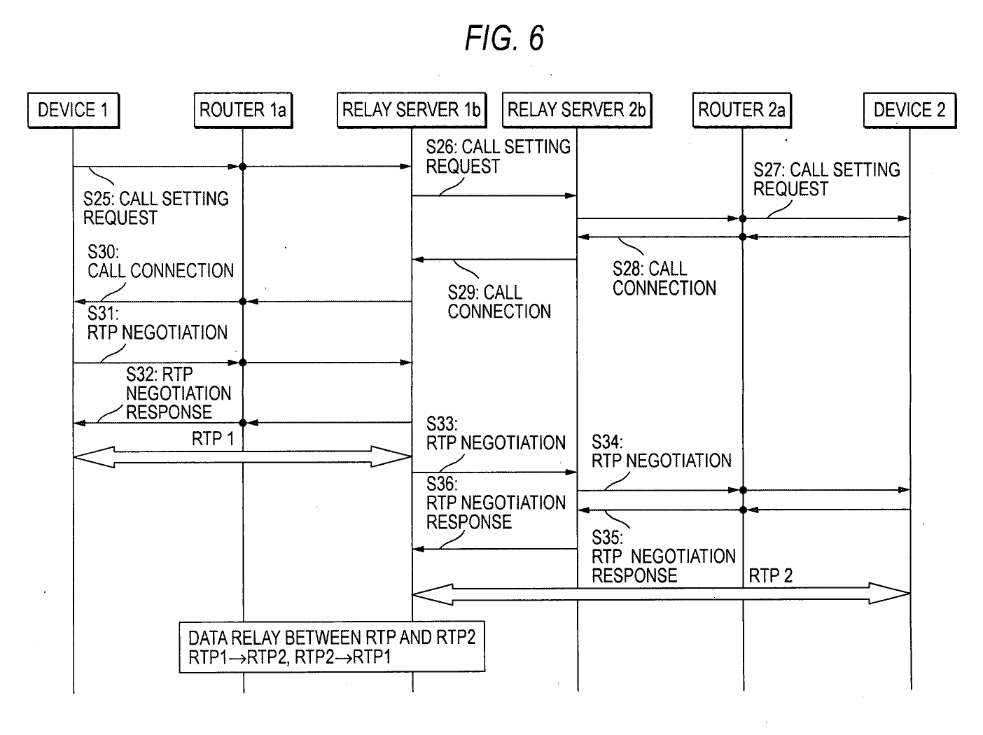

FIG. 6 is an exemplary sequence diagram showing a communication procedure between terminals of the case of a communication enabling NG according to the embodiment. In this sequence, a signal between IP communication devices is relayed by a relay server. A procedure from S25 to S36 is similar to the procedure from S10 to S21 of FIG. 5.

In FIG. 6, the relay server 1b determines that the router 1a or the router 2a does not permit access from another device in accordance with the management table of FIG. 7, and sends voice/video data, fax and modem data sent from the IP communication device 1 through an RTP1 to the IP communication device 2 through an RTP2. Also, the relay server 1b sends voice/video data, fax and modem data sent from the IP communication device 2 through the RTP2 to the IP communication device 1 through the RTP1. Thus, the relay server 1b relays a signal between the IP communication device 1 and the IP communication device 2 and thereby, communication between the IP communication device 1 and the IP communication device 2 can be conducted.

FIG. 8 is an exemplary diagram showing one example of a management table used by the relay server to relay the signal between IP communication devices according to the embodiment. In FIG. 8, different UDP ports for RTP 1 and RTP 2 are generated. A UDP port number 1 for RTP 1, and an IP address and a port number of the IP communication device 1 which is a communication destination are described in a self-UDP port number 1, and an IP address and a port number. Also, a UDP port number 2 for RTP 2, and an IP address and a port number of the IP communication device 2 which is a communication destination are described in a self-UDP port number 2, and an IP address and a port number. The RTP 1 and the RTP 2 may be communicated by the same UDP port in order to decrease the number of UDP ports used in a relay server.

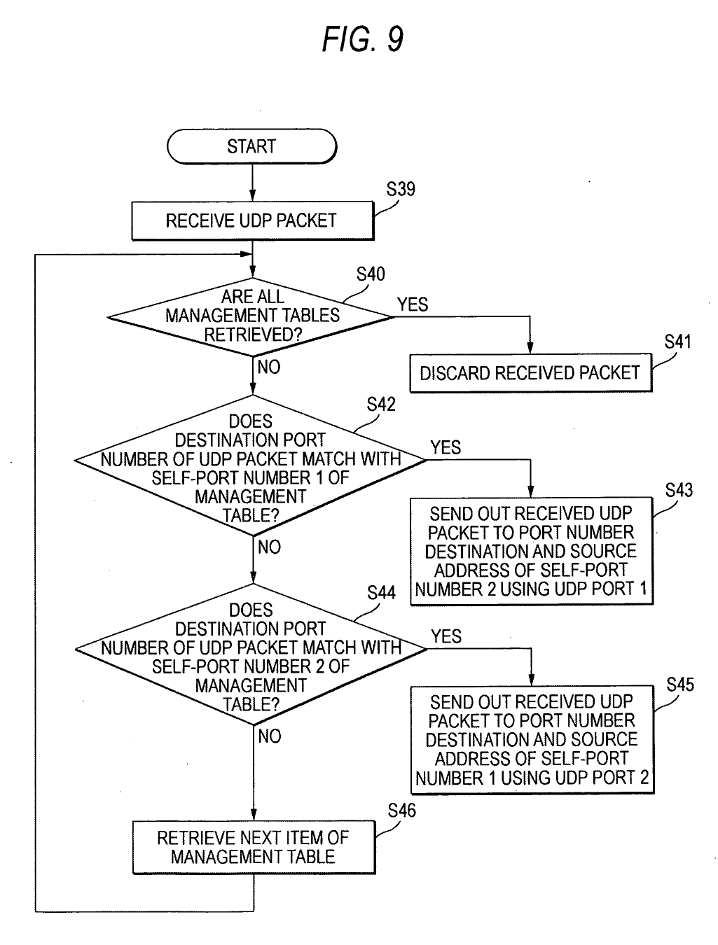

FIG. 9 is an exemplary flowchart showing a processing procedure of a packet relay in the relay server according to the embodiment A relay server receives a UDP packet in S39 of FIG. 9, and checks whether or not a destination port number described in a UDP header of the received UDP packet matches with self-port number 1 and self-port number 2 of the relay management table shown in FIG. 8 sequentially from the head.

When the destination port number described in the UDP header of the received UDP packet matches with self-port number 1 of the relay management table shown in FIG. 8 (S42), the relay server sends the received UDP packet to a port number of a destination IP address of self-port number 2 using a UDP port 2 (S43).

When the destination port number described in the UDP header of the received UDP packet matches with self-port number 2 of the relay management table shown in FIG. 8 (S44), the relay server sends the received UDP packet to a port number of a destination IP address of self-port number 1 using a UDP port 1 (S45). The processing of S42, S43, S44 and S45 is performed with respect to all the items of the management table of FIG. 8 (S40, S46). When all the management tables of FIG. 8 do not match with self-port number 1 and self-port number 2, the received UDP packet is discarded (S41).

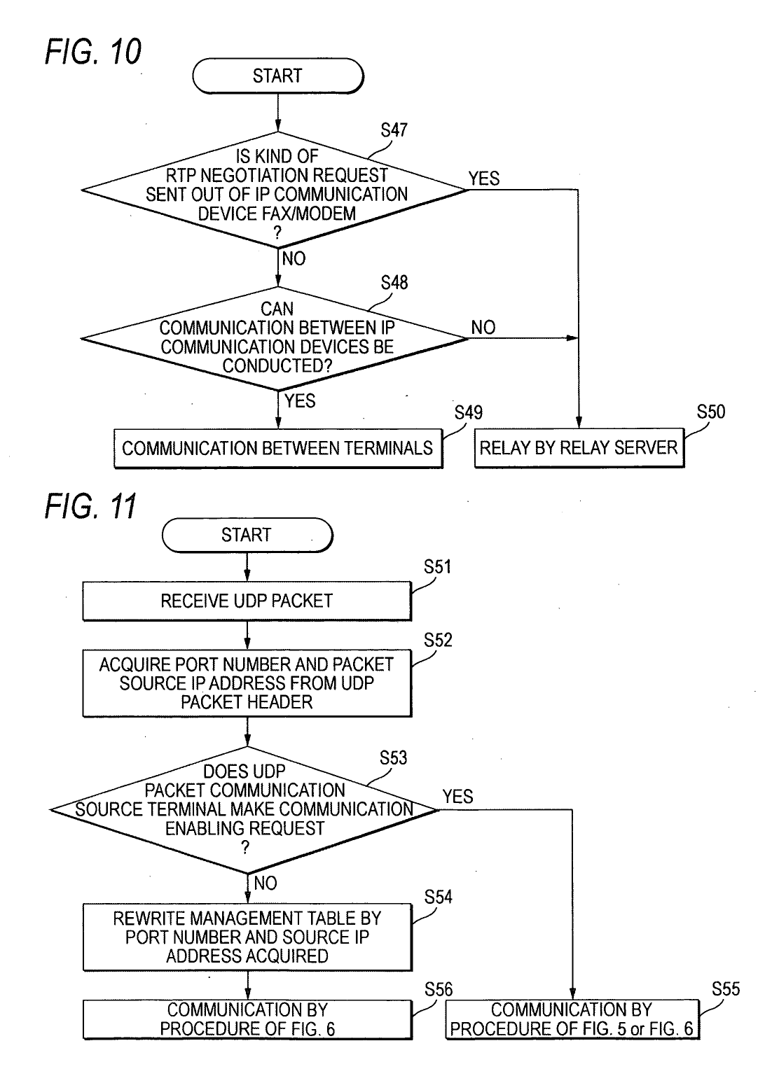

FIG. 10 is an exemplary flowchart showing a processing procedure of the case of determining whether the relay server relays the signal between IP communication devices based on a kind of the communication according to the embodiment. Here, communication data kinds of voice, video, a fax, a modem, etc. are described in an RTP negotiation request sent from an IP communication device. A source IP communication device describes the kind as voice when communication conducted from now is voice, as video when the communication is video, as fax when the communication is fax, as modem when the communication is modem data, and sends the kind to the relay server.

The relay server receives the RTP negotiation request from the IP communication device, and determines a communication data kind described in the RTP negotiation request (S47). In the case of interfering with communication by switching of a communication destination, for example, a fax or a modem, a signal between the IP communication device 1 and the IP communication device 2 by the procedure of FIG. 6 is relayed by the relay server (S50). On the other hand, when switching of a communication destination does not interfere with communication, for example, voice or video communication, it is determined whether or not communication between the IP communication devices can be conducted by referring to the management table of FIG. 7 (S48). When the communication between the IP communication devices can be conducted, the processing of FIG. 5 is performed and voice/video communication between the IP communication devices is conducted (S49). When the communication between the IP communication devices cannot be conducted, the processing of FIG. 6 is performed and the relay server relays a signal between the IP communication devices (S50).

FIG. 11 is an exemplary flowchart showing a processing procedure of the relay server to change an IP address and a port number of a relay destination terminal in case that an IP communication device has not made a connection enabling request according to the embodiment. First, as a preprocessing stage, when a relay server receives an outgoing request from an IP communication device which is not registered in the management table of FIG. 7, the relay server generates one UDP port for communicating with the IP communication device 1 and one UDP port for communicating with the IP communication device 2. The relay server generates a UDP communication path of an RTP1 between the IP communication device 1 and the relay server and a UDP communication path of an RTP2 between the IP communication device 2 and the relay server using the procedure of FIG. 6.

When generation of the RTP1 and the RTP2 is completed, the relay server describes a UDP port number, an IP address of the IP communication device 1 of a communication destination and self-UDP port number used in the RTP1 in a port number, a destination IP address of self-UDP port 1 and self-UDP port number 1 of the management table of FIG. 8. Also, the relay server describes a UDP port number, an IP address of the IP communication device 2 of a communication destination and self-UDP port number used in the RTP2 in a port number, a destination IP address of self-UDP port 2 and self-UDP port number 2 of the management table of FIG. 8.

As shown in FIG. 11, when the relay server receives a UDP packet from the IP communication device through the processing described above (S51), an IP address and a port number of a source are acquired from header information about the received UDP packet (S52). The relay server checks whether or not a source IP address acquired from the header information about the received UDP packet is described in the management table of FIG. 7, and determines whether or not a sending enabling request has been done (S53). When a communication enabling request has been done, communication is conducted by the procedure of FIG. 5 or FIG. 6 (S55).

When the communication enabling request has not been done, the relay server compares the received UDP packet source port number with self-UDP port number 1 and self-UDP port number 2 of the relay destination management table of FIG. 8. When the received UDP packet source port number matches with self-UDP port number 1 of the relay destination management table of FIG. 8, the relay server rewrites a destination IP address and a port number of self-UDP port 1 by a source IP address and a port number of the received UDP packet.

When the received UDP packet source port number matches with self-UDP port number 2 of the relay destination management table of FIG. 8, the relay server rewrites a destination IP address and a port number of self-UDP port 2 by a source IP address and a port number of the received UDP packet (S54). After the management table of FIG. 8 is rewritten, the relay server performs relay processing by the procedure of FIG. 6. Therefore, even when the IP communication device communicates with the relay server through the NAT router, the relay server can relay a signal to an IP address and a port number after being converted by a NAT router.

In this embodiment as described above, in the case of configuring a voice/video communication system by connecting plural different networks through routers in the voice/video communication system using an IP, plural relay servers 1b, 2b for relaying voice/video/fax/modem data and a call control signal to which a global IP address is assigned are prepared. Then, a system of a NAT router is determined by determining whether or not connection of a communication path between the relay servers 1b, 2b can be made using a test packet. The voice/video/fax/modem data is delivered between terminals in a peer-to-peer manner when the connection can be made based on this result. Thus, peer-to-peer communication between terminals is implemented where possible rather than conducting communication through the relay server always blindly.

Specifically, a connection enabling test is made by the following processes.

(1) A terminal/exchange controller notifies a relay sever (master relay server) of an IP address of the terminal/exchange controller by a UDP packet.

(2) The relay server receives the IP address sent from the terminal/exchange controller, and sends a packet to the terminal/exchange controller sending the IP address to another relay server (test relay server).

(3) When the test relay server receives a packet sent from another relay server, the test relay server is notified of a reception result.

(4) The test relay server, relaying a test packet to a terminal, notifies the master relay server of a test result.

Also, in this embodiment, information about the terminal/exchange controller on a network in which connection enabling or disabling has already been processed by a relay server is accumulated and determination of connection enabling or disabling is made based on recorded data. As a result of this, a load on the network and the relay server can be reduced. Further, when an error of communication between the relay server and a router occurs, the relay server deletes registration of communication enabling or disabling and the terminal/exchange controller again requests the communication enabling or disabling, so that a malfunction by replacement of the router, trouble of an IP terminal/PBX/button telephone/exchange server on a network, failure of the relay server, etc. can be prevented.

Also, in this embodiment, it is determined whether or not a signal sent and received by a terminal is relayed by a relay server in accordance with a kind of fax/modem communication etc. As a result of this, occurrence of a communication error because of influence of noise etc. caused by switching of a relay destination can be prevented.

Also, in this embodiment, voice/video/fax/modem data between destination terminals is relayed by a relay server when a communication request of voice/video/fax/modem data is made from a terminal in which a connection enabling request from a terminal to a relay server has not been done. This procedure is concretely performed by the following processes.

<1> A UDP port for communicating with a source terminal and a UDP port for communicating with a destination terminal are generated in a relay server.

<2> The source terminal is notified of a UDP port for communicating with the source terminal generated in the relay server and an IP address of the relay server as a communication destination. The destination terminal is notified of a UDP port for communicating with the destination terminal generated in the relay server and an IP address of the relay server as a communication destination.

<3> An IP address and a port number converted by a router are acquired from an IP packet header of voice/video/fax/modem data sent from the source terminal to the relay server, and the voice/video/fax/modem data sent from the destination terminal is sent to the IP address and the port number acquired.

By going through this procedure, even when communication with a relay server cannot be conducted at the time of starting a terminal, the terminal can conduct communication. From these, a communication control method constructed so that a load on the relay server can be reduced can be provided.

According to the embodiment of the invention, there is provided a communication control method to reduce a load on a relay server.

It is to be understood that the present invention is not limited to the specific embodiment described above and that the invention can be embodied with the elements modified without departing from the spirit and scope of the invention. The present invention can be embodied in various forms according to appropriate combinations of the elements disclosed in the embodiment described above. For example, some elements may be deleted from all elements shown in the embodiment. Further, the elements in different embodiments maybe used appropriately in combination.

What is claimed is:

1. A communication control method of a communication system which connects an IP network to plural networks including IP communication devices through routers provided for respective networks, which communicates between the IP communication devices of the different networks through the IP network with IP-packetized data, and which includes a first relay server and a second relay server which relay the IP packet and a control signal to which a global IP address is assigned, the method comprising:
determining whether peer-to-peer communication between the IP communication devices can be conducted by using a test packet through the first and second relay servers and the router;
conducting peer-to-peer communication of the IP data between the IP communication devices determined that the peer-to-peer communication can be conducted; and
relaying by the first relay server or second relay server between the IP communication devices determined that the peer-to-peer communication cannot be conducted.

2. The communication control method according to claim 1, wherein determining whether peer-to-peer communication between the IP communication devices can be conducted comprises:
sending a connection enabling request to which an IP address of the IP communication device is assigned, from the IP communication device to the first relay server,
including the IP address of the IP communication device, contained in the connection enabling request, in the test packet and sending the test packet from the first relay server to the second relay server;
sending the test packet from the second relay server to the IP communication device; and
deciding that the IP communication device can conduct the peer-to-peer communication when the IP communication device receives the test packet from the second relay server.

3. The communication control method according to claim 1, further comprising:
connecting the first relay server to a first IP communication device on a network and a second IP communication device on another network, when the second IP communication device capable of communicating with the second relay server communicates with the first IP communication device; and
notifying the first IP communication device and the second IP communication device of port numbers and IP addresses sent from the second IP communication device and the first IP communication device, respectively, and changing destinations of communication in the first and second IP communication devices in accordance with the notified IP address and port number.

4. The communication control method according to claim 1, wherein, when connection enabling processing is requested from an IP communication device on a network in which the determining has been performed, communication between IP communication devices is connected based on a result determined already.

5. The communication control method according to claim 1, wherein, when a communication error occurs between the first relay server and the router, the determining is again performed in a communication path in which the router is present.

6. The communication control method according to claim 1, further comprising: determining whether peer-to-peer communication between the IP communication devices is conducted based on a communication kind described in negotiation information sent from the IP communication device when data interfering with communication by changing processing of an opposite destination in communication is being communicated.

7. The communication control method according to claim 1, further comprising:
generating a port to communicate with a source IP communication device and a port to communicate with a destination IP communication device in the first relay server when the source IP communication device requests to communicate with the destination IP communication device, and the determining has not been performed;
notifying the source IP communication device of an IP address of the first relay server and a port number to communicate with the source IP communication device generated in the first relay server as a communication destination;
notifying the destination IP communication device of an IP address of the first relay server and a port number to communicate with the destination IP communication device generated in the first relay server as a communication destination;
acquiring IP addresses and port numbers converted by the routers in accordance with header information about IP packets sent from the source IP communication device and the destination IP communication device to the first relay server; and
sending an IP packet sent from the destination IP communication device to the IP address and the port number acquired in accordance with the packet sent from the source IP communication device; and
sending an IP packet sent from the source IP communication device to an IP address and a port number acquired in accordance with the packet sent by the destination IP communication device.

8. The communication control method according to claim 1, wherein the IP communication devices are communicated through different communication channels for the control signal and the IP-packetized data.
